(19) United States
(12) Patent Application Publication
(10) Pub. No.: US 2006/0071746 A1
(43) Pub. Date: Apr. 6, 2006

(54) Vibration and locking system

(75) Inventor: Marko Lylyharju, Salo (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/956,139

(22) Filed: Oct. 4, 2004

(51) Int. Cl. H01H 9/00

(52) U.S. Cl. 335/205

(57) ABSTRACT

There is being disclosed a portable electronic apparatus, such as a mobile phone, comprising a body and at least partly covering lid pivotally mounted to the body by a hinge. The apparatus includes and a permanent magnet and an electromagnetic coil for generating a controllable magnetic flux between the lid and the body of the portable electronic apparatus. By supplying a current through a wire in the coil suspended between the poles of the permanent magnet the wire experiences a magnetic force. An embodiment can be used for vibrating the portable electronic apparatus, locking the lid and the body of the apparatus together and indicating a position of the lid.

### TECHNICAL FIELD OF THE INVENTION

The invention concerns a portable electronic apparatus according to a preamble of claim 1. Furthermore, the invention concerns a mobile phone according to a preamble of claim 19. Still furthermore, the invention concerns a portable electronic apparatus system according to a preamble of claim 37.

### BACKGROUND ART

Portable electronic apparatuses, such as mobile phones and personal digital assistants, are typically equipped with a generator that provides a vibration alarm. A small-sized dc motor arranged into the apparatus is used as a source of vibration, in which the vibration is generated by the small weights. The weights are mounted eccentrically on the shaft of the dc motor. When the dc motor is started the weights are rotated with the shaft generating vibration due to the inertial force of the eccentric weight. The vibration propagates to the apparatus and causes alert to the user. The dc motor can be used as the source of vibration if there is enough space available in the interior of the portable electronic apparatus. If the space is limited by the physical size of the portable electronic apparatus the size of the dc motor should be reduced respectively. Furthermore, this kind of solution is expensive and therefore generally unsatisfactory.

The above problems are emphasized in the portable electronic apparatuses consisting of a body and a lid pivotally mounted to the body by a hinge, for example in the mobile phones of shell type. The lid of the apparatus is movable between an open and a closed position and provided conventionally with a locking mechanism in the body of the apparatus. The locking mechanism is typically mechanical comprising for example a spring for tensioning the lid to the closed position and a release button for releasing the lid to the open position. The foldable structure of the portable electronic apparatus reduces the space required for the components used in the apparatus.

### SUMMARY OF THE INVENTION

It is therefore an object of the invention to provide a portable electronic apparatus, a mobile phone and a portable electronic apparatus system to better meet the foldable structure requirements than in the known art.

This object is achieved by the portable electronic apparatus according to claim 1. In accordance with further aspects of the invention, there is also provided a mobile phone according to claim 19 and a portable electronic apparatus system according to claim 37. Furthermore, there is being provided the use of such apparatuses.

The invention utilizes magnetic flux generating means for generating a controllable magnetic flux between the lid and the body of the portable electronic apparatus which means requires less space for the implementation, thereby enabling to follow the structural, functional and design requirements of the portable electronic apparatus.

Furthermore, the weight of the portable electronic apparatus can be reduced since a movable mass used for vibration, for example the lid or the body of the apparatus, is a part of an existing mass of the apparatus. Furthermore, the movements of the pivotally mounted lid can be detected electrically. Furthermore, forces enabling the magnetic flux between the lid of the apparatus and the body of the apparatus are generated.

In further embodiments, the magnetic flux generating means comprises a permanent magnet and an electromagnetic coil that is so disposed as to intersect a magnetic flux of the permanent magnet for generating the controllable magnetic flux.

In further embodiments of the invention, the permanent magnet is adapted to be supported by a conductor to conduct a magnetic field and mounted to the lid of the portable electronic apparatus, and the electromagnetic coil is adapted to be supported by a body of the electromagnetic coil and mounted to the body of the portable electronic apparatus. Furthermore, the magnets are arranged so that the lid being in a closed position, that is placing the lid substantially flush with the body of the portable electronic apparatus, one of the magnetic poles of the permanent magnet is positioned upon the beginning of the electromagnetic coil, and the other magnetic pole of the permanent magnet is positioned upon the end of the electromagnetic coil.

According to another further embodiments of the invention the permanent magnet has a shape of oblong and is supported by the conductors in the both ends of the permanent magnet. In addition, the electromagnetic coil has a shape of cylinder and is supported by the conductors in the both ends of the coil and by a conductor rod positioned axially in the centre of the cylinder coil. The conductors are made of steel, for example.

In another further embodiments of the invention, the lid of the portable electronic apparatus and the body of the portable electronic apparatus are adapted to be locked together. Furthermore, in another further embodiments of the invention, the lid and the body of the portable electronic apparatus are locked together by the controllable magnetic flux.

According to further embodiments of the invention the lid and the body of the portable electronic apparatus are adapted to be locked together by the magnetic forces of the controllable magnetic flux. Thus, the lid and the body of the portable electronic apparatus are adapted to be locked together either by the magnetic attraction or by the magnetic repulsion.

In another further embodiments of the invention, the vibration of the portable electronic apparatus is generated by the controllable magnetic flux. That is the vibration of the portable electronic apparatus is due to the interaction of a current signal of varying pulses passing through the electromagnetic coil and the magnetic field. Such varying current signal may be a sine wave or a saw-tooth wave and advantageously a square wave. The frequency of the current signal may be dependent on either the natural frequency of the components arranged in the portable electronic apparatus, such as the lid, or the audible frequency or both. Furthermore, in another further embodiments of the invention, the frequency of the current signal supplied to the coil is audible frequency. Such frequency may be constant.

In another further embodiments of the invention, the frequency of the current signal supplied to the coil is variable frequency. Thereby, the frequency of current signal of varying pulses may be increased if desired and thus the vibration of the portable electronic apparatus is increased. Respectively, the frequency of current signal of varying pulses may be decreased and thus the vibration of the portable electronic apparatus is decreased.

In another further embodiments of the invention, the amplitude of the current signal supplied to the coil is constant. Furthermore, in another further embodiments of the invention, the amplitude of the current signal supplied to the coil is variable.

In another further embodiments the current supplied to the coil in the magnetic field, for example from an external power supply, produces electromagnetic force that either pull or push the permanent magnet depending on the current direction. Since the electromagnetic coil is arranged to form part of the closed circuit through which a current is flowing, electrical power is generated. The power consumption of the magnetic circuit thus varies during the cycle of the varying current pulse. Depending on the physical size of the portable electronic apparatus, the power required from the power supply is around 150 mW-1 W, for example. In yet another further embodiment of the invention, a spring force can be used to either pull or push the lid with respect to the body. Thereby the opening, closing or vibrating force can be partly based on the spring force combined with the force generated by the electromagnetic flux.

According to further embodiments of the invention the position of the lid relative to the body of the portable electronic apparatus is indicated using the voltage induced by the permanent magnet wherein the lid position is provided for triggering other external devices connected to the portable electronic apparatus, for example, for interrupting the CPU at desired positions of the lid.

### BRIEF DESCRIPTION OF THE DRAWINGS

The invention will now be described by way of examples only with reference to the accompanying drawings, in which:

FIG. 1 depicts mechanical parts for a portable apparatus in accordance with a further embodiment of the invention,

FIG. 2 depicts the structure for a portable apparatus according to a further embodiment of the invention,

FIG. 3 depicts an example of implementation for a portable apparatus according to a further embodiment of the invention,

FIG. 4a depicts an example of implementation for a portable apparatus according to a further embodiment of the invention,

FIG. 4b depicts an example of implementation for a portable apparatus according to a further embodiment of the invention.

### DESCRIPTION OF FURTHER EMBODIMENTS

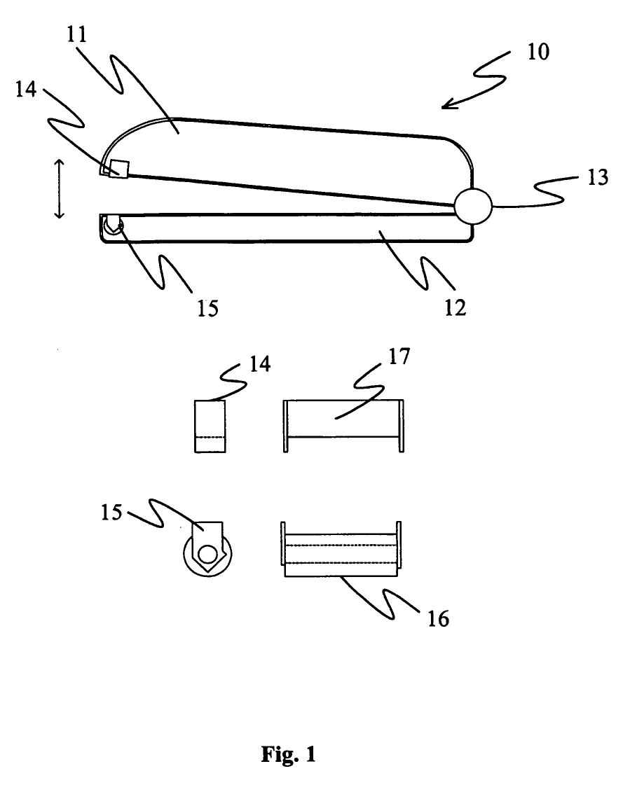

Mechanical parts for a portable electronic apparatus according to the further embodiment of the invention are depicted in FIG. 1. A movable lid 11 is pivotally mounted to the body 12 of the portable electronic apparatus 10 by a hinge 13. The apparatus 10 includes an oblong permanent magnet 17 in the edge of lid 11 and is supported by the steel plates 14 from the ends of the magnet 17. The portable apparatus 10 also includes an electromagnetic coil 16 in the edge of the body 12 of the apparatus and is supported by the body 15 for the coil. The coil is supported from its ends and the centre by a steel rod of the coil body 15. The lid 11 is movable by the hinge 13 in the directions of upward and downward as shown by the arrows in FIG. 1.

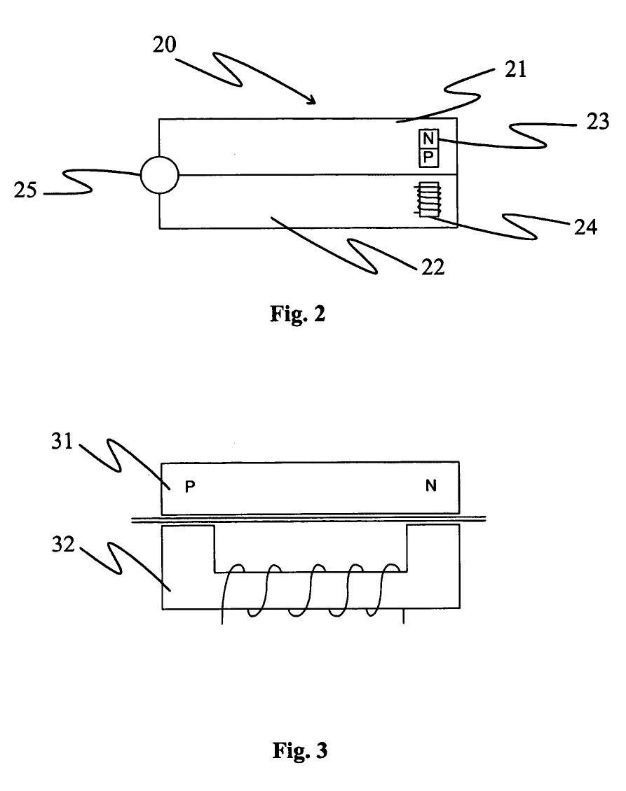

Referring to FIG. 2, the portable electronic apparatus presented can be analogical to the apparatus presented in FIG. 1 in some cases. The lid 21 of the apparatus 20 is provided with a permanent magnet 23 which poles are denoted as an P pole and an N pole in the upper part of the apparatus. The body 22 of the apparatus 20 is provided with an electromagnetic coil 24 in the lower part of the apparatus. The apparatus is provided with a hinge 25 between the lid and the body of the apparatus. The coil 24 is electrically connected to a power supply (not shown in FIG. 2) of the portable electronic apparatus 20 for passing a current signal through the coil 24.

Referring to the example of FIG. 3, when the lid of the portable electronic apparatus is in a closed position the lid is substantially flush with the body of the apparatus. The permanent magnet 31 has an oblong shape wherein an N pole of the magnet is in the one end of the magnet and a P pole is in the other end of the magnet as is depicted in the example of FIG. 3. The electromagnetic coil 32 is oblong in shape and is positioned below the permanent magnet 31 so that one magnetic pole is above the beginning of the coil 32 and the other magnetic pole is above the end of the coil 32.

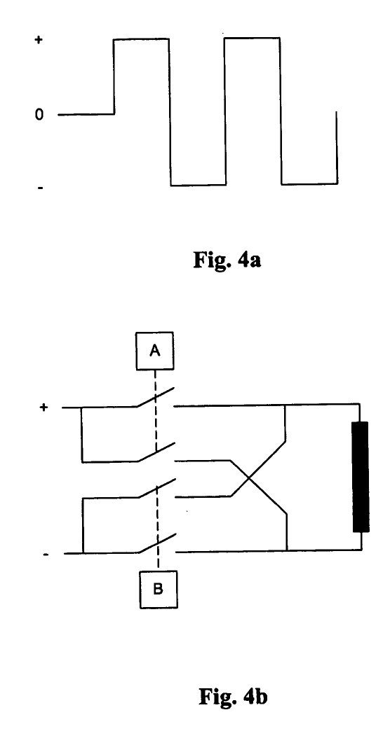

Thus, an electromagnetic coil and a permanent magnet form a magnetic circuit in the example of the portable electronic apparatus presented in FIG. 1-2. In FIG. 3, a magnetic field of a permanent magnet 31 causes magnetic forces to act on wires in the coil 32 carrying a current. If a current is passed through a wire suspended between the poles of the permanent magnet 31 the wire experiences a force perpendicular to the direction of the current and is deflected. If the direction of the current is reversed the deflection of the wire is reversed. Thus, magnetic forces direction is dependent on the current direction. By supplying an appropriate current of varying pulses, for example a current waveform of square wave as is presented in the example of FIG. 4a, through the coil 16 of the portable electronic apparatus 10 the lid 11 is moved upward and downward by the hinge 13 according to frequency of the current.

Referring to the further embodiment of FIGS. 4a and 4b, a current signal 4a produced by an electrical circuit 4b is depicted. The current signal 4a passing through the coil is provided by the power supply of the portable electronic apparatus that is connected to the terminal of an electromagnetic coil denoted as plus and minus signs in FIG. 4b. The waveform to be provided is preferably such that the direction of the current changes periodically and at the predetermined frequency and magnitude, as presented for example in FIG. 4a. As the switches connected to A are conducting and the switches connected to B disconducting the current waveform is either positive or negative. Respectively, when the switches A are disconducting and the switches B are conducting the current waveform is either negative or positive, as in FIG. 4a.

In another further embodiment of the invention, the magnetic circuit described above is utilized for locking the lid and the body of the portable electronic apparatus together i.e. into the closed position. Referring to the example of FIG. 1, the hinge 13 allows the lid to pivot relative to the body of the apparatus. For example, the lid may rotate into a partially open position, as in FIG. 1, an open position or a closed position as in FIG. 2. As shown in FIG. 1 the permanent magnet 17 is supported to the lid by the steel plates 14 and the coil 16 is supported to the body 12 of the apparatus 10 by the coil body 15, respectively. When the lid 11 is closed, the permanent magnet 17 and the coil 16 are substantially parallel with each other. Thus, if an appropriate current is passing through the coil the magnetic force engages the lid 11 with the body 12 of the apparatus 10. Although the permanent magnet is capable of locking the lid and the body of the portable electronic apparatus together, the locking is strengthened when small power, e.g. of around 150 mW, is drawn to the magnetic circuit.

In another further embodiment of the invention, the portable electronic apparatus is provided to indicate the position of lid. When the apparatus is subjected to an external force due to the current and the magnetic field the position of the lid can be determined by measuring the voltage induced by the permanent magnet. If the placement of the lid or the body of the apparatus has to be known, the short pulse of signal is supplied to the coil. A lid of the apparatus being either in an open or a closed position is detected by measuring the voltage over the electromagnetic coil. Thus, it enables that the opening or closing of the lid by the user can be detected.

From the foregoing description it is readily understood that the portable electronic apparatus according to some embodiments of the invention makes it possible to increase the flexibility in design of such apparatuses. The embodiments reduce parts count and simplify manufacture of the portable electronic apparatuses.

While the invention has been shown and described with reference to certain embodiments thereof, these are merely provided to illustrate the invention and should not construed as limitations of the invention's scope. Thus, it will be understood by those skilled in the art that various modifications in the form and details can be made therein without departing from the spirit and scope of the invention.

1. A portable electronic apparatus comprising:
a body;
an at least partly covering lid pivotally mounted to the body by a hinge; and
a magnetic flux generating means for generating a controllable magnetic flux between the lid and the body of the portable electronic apparatus.

2. A portable electronic apparatus according to claim 1, wherein the magnetic flux generating means comprises:
a permanent magnet, having two magnetic poles; and
an electromagnetic coil adapted to be so disposed as to intersect a magnetic flux of the permanent magnet for generating the controllable magnetic flux.

3. A portable electronic apparatus according to claim 2, wherein:
the permanent magnet is adapted to be supported by one or more conductors to conduct a magnetic field of the magnetic flux and is mounted to the lid of the portable electronic apparatus; and
the electromagnetic coil is adapted to be supported by a body of the electromagnetic coil and is mounted to the body of the portable electronic apparatus.

4. A portable electronic apparatus according to claim 3, wherein the lid, when placed in a closed position, is substantially flush with the body of the portable electronic apparatus, and a first magnetic poles of the permanent magnet is positioned upon a beginning of the electromagnetic coil, and a second magnetic pole of the permanent magnet is positioned upon an end of the electromagnetic coil.

5. A portable electronic apparatus according to claim 4, wherein the permanent magnet has an oblong shape and is supported by two conductors, one at each end of the permanent magnet.

6. A portable electronic apparatus according to claim 4, wherein the electromagnetic coil has a cylindrical shape and is supported by two conductors, one at each end of the coil and by a conductor rod positioned axially in a center of the cylindrical coil.

7. A portable electronic apparatus according to claim 4, wherein the position of the lid in relation to the body of the portable electronic apparatus is indicated using the voltage induced by the permanent magnet.

8. A portable electronic apparatus according to claim 7, wherein the indicated lid position is provided for triggering other external devices connected to the portable electronic apparatus.

9. A portable electronic apparatus according to claim 1, wherein the lid of the portable electronic apparatus and the body of the portable electronic apparatus are adapted to be locked together.

10. A portable electronic apparatus according to claim 9, wherein the lid of the portable electronic apparatus and the body of the portable electronic apparatus are adapted to be locked together by the controllable magnetic flux.

11. A portable electronic apparatus according to claim 9, wherein the lid of the portable electronic apparatus and the body of the portable electronic apparatus are adapted to be locked together by the magnetic forces of the controllable magnetic flux.

12. A portable electronic apparatus according to claim 9, wherein the lid of the portable electronic apparatus and the body of the portable electronic apparatus are adapted to be locked together by the magnetic attraction of the controllable magnetic flux.

13. A portable electronic apparatus according to claim 9, wherein the lid of the portable electronic apparatus and the body of the portable electronic apparatus are adapted to be locked together by the magnetic repulsion of the controllable magnetic flux.

14. A portable electronic apparatus according to claim 1, wherein a vibration of the portable electronic apparatus is generated by the controllable magnetic flux.

15. A portable electronic apparatus according to claim 14, wherein the controllable magnetic flux of the portable electronic apparatus is generated by the interaction of a current signal passing through the electromagnetic coil and the magnetic field.

16. A portable electronic apparatus according to claim 15, wherein the current signal passing through the electromagnetic coil is a sine wave.

17. A portable electronic apparatus according to claim 15, wherein the current signal passing through the electromagnetic coil is a saw-tooth wave.

18. A portable electronic apparatus according to claim 15, wherein the current signal passing through the electromagnetic coil is a square wave.

19. A mobile phone comprising:
a body;
an at least partly covering lid pivotally mounted to the body by a hinge; and
a magnetic flux generating means for generating a controllable magnetic flux between the lid and the body of the mobile phone.

20. A mobile phone according to claim 19, wherein the magnetic flux generating means comprises:
a permanent magnet, having two magnetic poles; and
an electromagnetic coil adapted to be so disposed as to intersect a magnetic flux of the permanent magnet for generating the controllable magnetic flux.

21. A mobile phone according to claim 20, wherein:
the permanent magnet is adapted to be supported by one or more conductors to conduct a magnetic field of the magnetic flux and mounted to the lid of the mobile phone; and
the electromagnetic coil is adapted to be supported by a body of the electromagnetic coil and mounted to the body of the mobile phone.

22. A mobile phone according to claim 21, wherein the lid, when placed in a closed position, is substantially flush with the body of the mobile phone, and a first magnetic poles of the permanent magnet is positioned upon a beginning of the electromagnetic coil, and a second magnetic pole of the permanent magnet is positioned upon an end of the electromagnetic coil.

23. A mobile phone according to claim 22, wherein the permanent magnet has an oblong shape and is supported by two conductors, one at each end of the permanent magnet.

24. A mobile phone according to claim 22, wherein the electromagnetic coil has a cylindrical shape and is supported by two conductors, one at each end of the coil and by a conductor rod positioned axially in a center of the cylindrical coil.

25. A mobile phone according to claim 22, wherein the position of the lid in relation to the body of the mobile phone is indicated using the voltage induced by the permanent magnet.

26. A mobile phone according to claim 25, wherein the indicated lid position is provided for triggering other external devices connected to the mobile phone.

27. A mobile phone according to claim 19, wherein the lid of the mobile phone and the body of the mobile phone are adapted to be locked together.

28. A mobile phone according to claim 27, wherein the lid of the mobile phone and the body of the mobile phone are adapted to be locked together by the controllable magnetic flux.

29. A mobile phone according to claim 27, wherein the lid of the mobile phone and the body of the mobile phone are adapted to be locked together by the magnetic forces of the controllable magnetic flux.

30. A mobile phone according to claim 27, wherein the lid of the mobile phone and the body of the mobile phone are adapted to be locked together by the magnetic attraction of the controllable magnetic flux.

31. A mobile phone according to claim 27, wherein the lid of the mobile phone and the body of the mobile phone are adapted to be locked together by the magnetic repulsion of the controllable magnetic flux.

32. A mobile phone according to claim 19, wherein a vibration of the mobile phone is generated by the controllable magnetic flux.

33. A mobile phone according to claim 32, wherein the controllable magnetic flux of the mobile phone is generated by the interaction of a current signal passing through the electromagnetic coil and the magnetic field.

34. A mobile phone according to claim 33, wherein the current signal passing through the electromagnetic coil is a sine wave.

35. A mobile phone according to claim 33, wherein the current signal passing through the electromagnetic coil is a saw-tooth wave.

36. A mobile phone according to claim 33, wherein the current signal passing through the electromagnetic coil is a square wave.

37. A portable electronic apparatus system comprising a body and an at least partly covering lid pivotally mounted to the body by a hinge, wherein the portable electronic apparatus system is configured to generate a controllable magnetic flux between the lid and the body of the portable electronic apparatus system.

38. A method for generating a controllable magnetic flux for a portable electronic apparatus comprising a body and at least partly covering lid pivotally mounted to the body by a hinge, the method comprising
generating said controllable magnetic flux between the lid and the body of the portable electronic apparatus.
